(19) United States
(12) Patent Application Publication
(10) Pub. No.: US 2026/0132014 A1
(43) Pub. Date: May 14, 2026

(54) KIT, SYSTEM, AND ASSOCIATED METHOD FOR FILLING SEALED DIRECT INJECT DELIVERY CARTRIDGES WITH REFRIGERANT GAS ADDITIVES

(71) Applicant: Thermofluid Technologies, Inc., Louisville, TN (US)

(72) Inventor: Floyd Eugene BREWER, II, Maryville, TN (US)

(21) Appl. No.: 19/395,856

(22) Filed: Nov. 20, 2025

Related U.S. Application Data
(63) Continuation-in-part of application No. 19/281,800, filed on Jul. 28, 2025.
Application No. 19/281,800 is a continuation-in-part of application No. 19/242,047, filed on Jun. 18, 2025.

(51) Int. Cl. B67D 7/02; F25B 45/00

(52) U.S. Cl. CPC B67D 7/0294; F25B 45/00; F25B 2345/006

(57) ABSTRACT

A kit defined by various components, a system, and a method for filling a new direct inject cartridge and for refilling an empty used direct inject cartridge. In various embodiments, the invention provides a kit consisting of valves for selectively providing fluid communication between a canister containing a selected volume of at least one selected refrigerant additive and a direct inject cartridge, and for selectively providing fluid communication between a direct inject cartridge and a vacuum pump for filling a direct inject cartridge, and a method for using the disclosed kit and system for filling a direct inject cartridge.

### CROSS-REFERENCE TO RELATED APPLICATIONS

This Non-Provisional Patent Application claims the benefit of U.S. Non-Provisional application Ser. No. 19/242,047, filed on Jun. 18, 2025, and U.S. Non-Provisional application Ser. No. 19/281,800, filed on Jul. 28, 2025, each of which is incorporated herein in its entirety by reference.

### STATEMENT REGARDING FEDERALLY SPONSORED RESEARCH OR DEVELOPMENT

Not Applicable

### BACKGROUND OF THE INVENTION

### 1. Field of Invention

The present disclosure relates to direct inject sealed delivery devices, both cartridge style and syringe style, for injecting chemical products, such as tire sealants, which are injected into vehicle tires and refrigerant gas additives, such as drying agents, conditioners, decontaminants, or sealants, which are injected into HVAC systems, vehicle air conditioning systems, or refrigeration systems, broadly referred to herein as chilling systems. More specifically, it relates to a kit, system, and an associated method for filling or refilling a direct inject sealed delivery devices. In a further exemplary embodiment, the present disclosure also relates to a three-valve manifold for servicing a chilling system through the low-pressure port of such system. The three-valve manifold provides for adding either refrigerant gas, refrigerant gas additives, or a combination of refrigerant gas and refrigerant gas additives to such chilling system without requiring a hose between the canister of refrigerant gas and/or refrigerant gas additive and the low pressure port of such system thereby reducing the risk of venting the refrigerant gas and/or refrigerant gas additive to the atmosphere during the steps of connecting or disconnecting the manifold from such system.

### 2. Description of the Related Art

In the field of maintaining chilling systems, such as HVAC systems, automotive air conditioning systems or refrigeration systems for refrigerated appliances, it is known that refrigerant additives are commonly added to the refrigerant gases. Such refrigerant additives can include sealants, including conditioners for rubber components such as O-rings, lubricants, dyes, such as UV dyes used for leak detection, system enhancers for reducing energy use or improving heat transfer, and drying agents. Frequently, these additives are sold in pre-measured, sealed delivery cartridges designed to inject these additives directly into the chilling system without needing to recharge the system first. These pre-measured, sealed delivery devices are commonly referred to as “direct injects” and are available as both cartridge style and syringe style devices. As used herein, “direct inject cartridges” refer to canister-style, pre-measured sealed delivery cartridges. Further, as used herein, “syringe-style direct inject” refers to the syringe style direct inject devices. The terms “direct inject” without a modifier or “direct inject delivery device” refer collectively to cartridge and syringe-style devices.

As recognized by those skilled in the art, direct injects are typically connected via the low pressure side service port. Because many of the refrigerant additives that are frequently used with direct injects are subject to being polymerized or oxidized upon exposure to air, and can be contaminated by moisture in ambient air, the direct inject cartridge is sealed against exposure to the atmosphere or moisture. It will be understood that state-of-the-art direct inject cartridges have a translucent body fabricated of a polymer or a plastic. This creates an attendant risk that ambient moisture can be absorbed through the polymer or plastic body and contaminate the chemical product contained therein. To avoid the possibility of air or moisture seeping into the sealed direct inject cartridge, direct inject cartridges are typically sold in sealed, air-tight packages, as seen in Prior Art FIG. 1A. Typically, this package will also contain a desiccant pack.

Those skilled in the art recognize and understand that direct inject cartridges commonly have a self-sealing valve, commonly a Schrader-Type valve disposed at each end and a cylindrical cartridge body disposed between the two valves. These self-sealing valves are adapted to engage the low pressure port on the A/C system and similar valves on hoses and vacuum pumps designed to be compatible with an A/C system and the equipment utilized to maintain such a system. Those skilled in the art understand that with a Schrader-Type Valve and other similar valves, the valve opens when pressed and, once disconnected and the pressure on the valve is released, the valve automatically resets and seals. As understood, when manufactured, direct inject cartridges are initially filled with nitrogen which is blown through the direct inject cartridge. This step forces oxygen from the cartridge. Then, the refrigerant additive is blown into the cartridge under pressure. When the cartridge is filled with the refrigerant additive, it is not uncommon for excess refrigerant additive to escape the cartridge as it is being removed from the filling apparatus. This excess refrigerant additive is typically exposed to the atmosphere, thereby potentially exposing those working on the filling process to the refrigerant additives. Further, those skilled in the art will recognize that canister-style direct inject cartridges are single-use products and are considered disposable. This results in the metal and plastic components of the direct inject ending up in a landfill and the attendant risk of the landfill being exposed to chemical residue associated with the additives previously contained within the direct inject cartridge. It will also be understood by those skilled in the art that while state-of-the-art direct inject cartridges are constructed so as to be retain liquid without leakage, they are not, as understood, air-tight so as to maintain an internal vacuum.

It is also known in the art that direct inject sealed delivery devices are also available as syringe-style direct injects. One such syringe-style direct inject 420, shown in package 350 as illustrated in Prior Art FIG. 12, includes, as is common with syringes, a barrel, or cylindrical body 430, a nozzle, a plunger seal, and some mechanism for pressing the plunger seal through the barrel to push the additives out of the nozzle. As is known in the art, package 350 may also include an optional extension, or adapter, hose 375. While it is known in the art that with certain syringe-style have a traditional integral plunger, plunger seal, and plunger shaft, others, such as the syringe-style direct inject illustrated in FIG. 12, have a plunger actuator 380, typically having a jack screw, that when the handle is rotated, the jack screw engages the plunger. The syringe-style direct inject plunger, in cooperation with a plunger actuator 380 manually compresses the pre-measured refrigerant additive through the nozzle which is adapted via a threaded or quick-connect fitting to engage the low-pressure service port of a typical chilling system. When the plunger is depressed, internal pressure forces the additive through the service hose and valve fitting into the system, often assisted by residual system vacuum or with the aid of a pressure differential.

Further, It will be readily recognized by those skilled in the art that state-of-the-art chilling systems require periodic maintenance in regard to replenishing the amount of refrigerant within the system. Additionally, other refrigerant gas additives are also often injected into the system during this maintenance. Replenishing the amount of refrigerant gas within chilling system requires connecting a supply of refrigerant to chilling system's low-pressure port.

As will be understood by those skilled in the art, refrigerant gases are typically charged into the chilling system low-pressure port through a hose. Whether it is a hose that is part of an automotive DIY kit, or one of the hoses of a state-of-the-art manifold gauge set. And, it will be recognized by those skilled in the art, that when the hose containing refrigerant gas, or a refrigerant gas additive is disconnected from a chilling system low pressure port, or when the hose is disconnected from the refrigerant gas cannister, there is a risk of discharging a volume of refrigerant gas to the atmosphere. Not only is this wasteful, it will also have a detrimental impact on the atmosphere.

What is missing from the art is a kit and associated system for quickly and efficiently refilling a direct inject so that the direct inject can be reused. What is further missing from the art is a method of filling a direct inject, either filling the direct inject initially during manufacture or refilling the direct inject for reuse, that utilizes a closed, or sealed system that minimizes release of refrigerant additive to the atmosphere and that allows used direct injects to be recycled, refilled, and reused thereby reducing the burden of chemical, plastic, and metal waste currently being disposed and burdening landfills.

What is further missing from the art is a three-valve manifold that is adapted to be secured to a cannister of refrigerant gas and/or refrigerant gas additive, a vacuum pump, and also to be secured directly, without the necessity of an intervening hose between the three-valve manifold and the low-pressure port of the HVAC or refrigeration system.

### BRIEF SUMMARY OF THE INVENTION

The present disclosure is directed towards various components, assemblies, and methods for filling a new direct inject cartridge and for refilling an empty used direct inject cartridge. In various embodiments, the disclosed apparatus and method provide a kit of components that may be provided together and used, in conjunction with a vacuum pump for filling a direct inject cartridge, a system in which the components are assembled and interact to facilitate filling a direct inject cartridge, and a method for using the disclosed kit and system for filling a direct inject cartridge.

### BRIEF DESCRIPTION OF THE SEVERAL VIEWS OF THE DRAWINGS

The above-mentioned features of the present disclosure will become more clearly understood from the following detailed description read together with the drawings in which:

FIG. 1A is a drawing of the prior art packaging for a direct inject additive delivery device;

FIG. 1B is a perspective view of a prior art can tap commonly used with aerosol cans of refrigerant gas and/or refrigerant gas additives;

FIG. 1C is a perspective view of a prior art, non-aerosol type canister having a foil seal;

FIGS. 2A, 2B, and 2C are perspective views of an exemplary embodiment of the direct inject filling system of the present apparatus;

FIG. 2D is a perspective view of a further exemplary embodiment of the direct inject filling system of the present apparatus;

FIG. 3A is a perspective view of an exemplary embodiment of the kit of the present apparatus for filling a direct inject cartridge as shown in FIG. 2A;

FIG. 3B is a perspective view of a further exemplary embodiment of the kit of the present apparatus for filling a direct inject cartridge as shown in FIG. 2D;

FIG. 4A is an exploded perspective view of the kit of the present apparatus for filling a direct inject cartridge as shown in FIG. 2;

FIG. 4B is a perspective view of the canister of the present apparatus shown as illustrated in FIG. 4A;

FIG. 4C is a perspective view of an exemplary embodiment of an improved cartridge-style direct inject that has a brass body with a sight glass;

FIGS. 4D and 4E are perspective views, with FIG. 4E being in partial section, of the first valve member of the present apparatus;

FIG. 4F is a perspective view of a further embodiment of the first valve member of the present apparatus;

FIG. 4G is a perspective view of a further embodiment of the first valve member illustrated in FIG. 4F in which the T-fitting and the second valve member are integral such that the second valve member and the first valve member are integral;

FIG. 5 is a perspective view of an alternate embodiment of the direct inject cartridge filling system of the present apparatus;

FIG. 6 is a further perspective view of a portion of the alternate embodiment illustrated in FIG. 5;

FIG. 7 is an exploded view of the embodiment illustrated in FIG. 5;

FIG. 8 is a further perspective view of the embodiment illustrated in FIG. 5 in which the optional pressure gauge has been removed for clarity of view, and in which both the first and second valve are in the closed position;

FIG. 9 is a further perspective view of the embodiment illustrated in FIG. 5 in which the optional pressure gauge has been removed for clarity of view, and in which the first valve is in the closed position, and the second valve is in the open position;

FIG. 10 is a further perspective view of the embodiment illustrated in FIG. 5 in which the optional pressure gauge has been removed for clarity of view, and in which the second valve has been closed, and the first valve has been opened to fill the attached direct inject cartridge;

FIG. 11 is a flow chart showing the steps of the method of filling a direct inject sealed delivery device;

FIG. 12 is a plan view showing one style of a prior art syringe-style direct inject in a retail package;

FIG. 13 is a perspective view of a further exemplary embodiment of the syringe-style direct inject filling system of the present apparatus;

FIGS. 14A and 14B are perspective views of an exemplary embodiment of the syringe-style direct inject filling system of the present apparatus;

FIG. 15 is an exploded perspective view of the kit of the present apparatus for filling a syringe-style direct inject as shown in FIG. 13;

FIG. 16 is a flow chart showing the steps of the method of filling a syringe-style direct inject sealed delivery device;

FIG. 17A is a perspective view of a further embodiment of the can tap, adapted as a three-valve manifold, including a first valve member, a second valve member and a third valve member for servicing a low-pressure port of a chilling system;

FIG. 17B is an elevation view in cross-section of the three-valve manifold of the present apparatus as illustrated in FIG. 17A;

FIG. 18 is a perspective view of the three-valve manifold, as illustrated in FIG. 17A in which the third valve body has been secured to the low-pressure port, (shown in phantom), of a chilling system;

FIG. 19 is a perspective view of the three-valve manifold, as illustrated in FIG. 18 in which the second valve body has been secured to a vacuum hose and in which the second and third valve actuators have been moved to the open position;

FIG. 20 is a perspective view of the three-valve manifold, as illustrated in FIG. 19 in which the second and third valve actuators have been moved to the closed position, isolating the negative pressure state of the chamber and the vacuum hose has been removed for convenience and clarity of view;

FIG. 21 is a perspective view of the three-valve manifold, as illustrated in FIG. 20 in which a container of refrigerant gas additive has been secured to the can-tap of the first valve body, and the first valve actuator has been opened allowing a selected portion of the refrigerant gas to fill the chamber;

FIG. 22 is a perspective view of the three-valve manifold, as illustrated in FIG. 21 in which the container of refrigerant gas additive has been removed from the can-tap of the first valve body and the first valve actuator has been moved to a closed position;

FIG. 23 is a perspective view of the three-valve manifold, as illustrated in FIG. 21 in which a container of refrigerant gas has been secured to the can-tap of the first valve body and the first and third valve actuators have been moved to the open position, allowing the refrigerant gas and the refrigerant gas additive in the chamber to flow through the low pressure port into the chilling system; and

FIGS. 24A and 24B are a flow chart showing the steps of the method of servicing a chilling system using the three-valve manifold according to the present disclosure.

### DETAILED DESCRIPTION

The present disclosure is directed towards various components, assemblies, and methods for filling a new direct injects and for refilling empty used direct injects. In various embodiments, the disclosure provides a kit of components that may be provided together for filling a direct inject, a system in which the components are assembled and interact to facilitate filling a direct inject, and methods for filling a direct inject. The kit and the system are adapted for use in the disclosed method. As mentioned above, the term “direct inject” used without a modifier refers to pre-measured sealed delivery devices which are available in both cartridge style devices and syringe-style devices. It will be understood that cartridge style direct injects have self-sealing Schrader-Type valves, referred to herein simply as Schrader valves and are designed to inject chemical products, such as tire sealants or refrigerant gas additives directly into an air conditioning system. Such refrigerant gas additives can include sealants, including conditioners for rubber components such as O-rings, lubricants, dyes, such as UV dyes used for leak detection, system enhancers for reducing energy use or improving heat transfer, drying agents, or a combination of two or more of such additives. As stated above, as used herein, the phrase “chilling system” refers broadly to an HVAC system, a chilling system for a refrigerated appliance such as refrigerators, freezers, room air conditioners, small ice makers, wine coolers, etc., or an automotive air conditioning system.

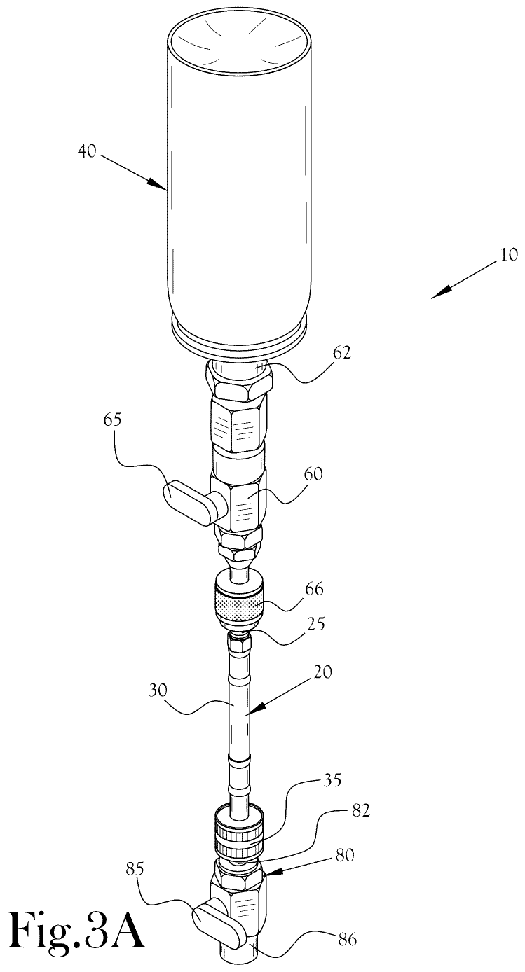

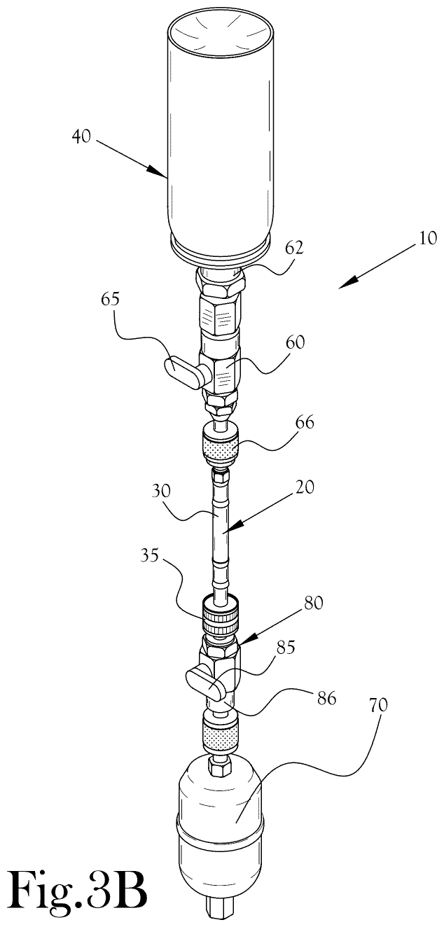

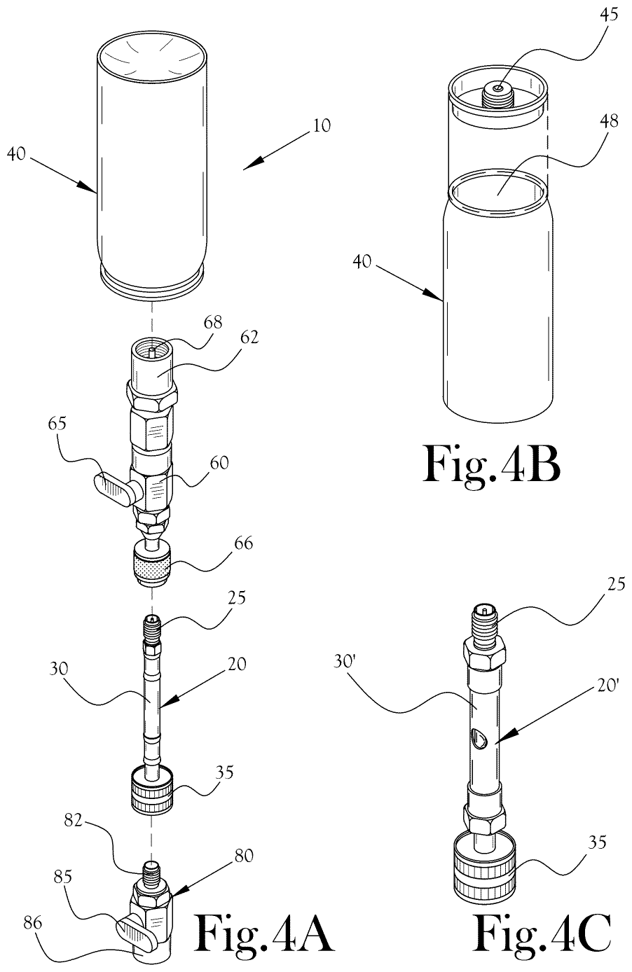

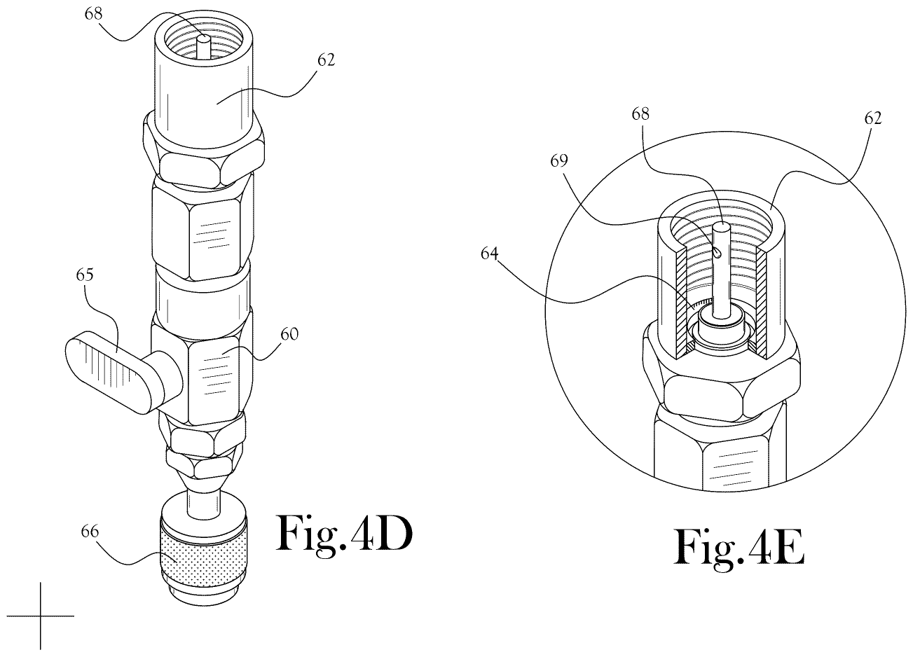

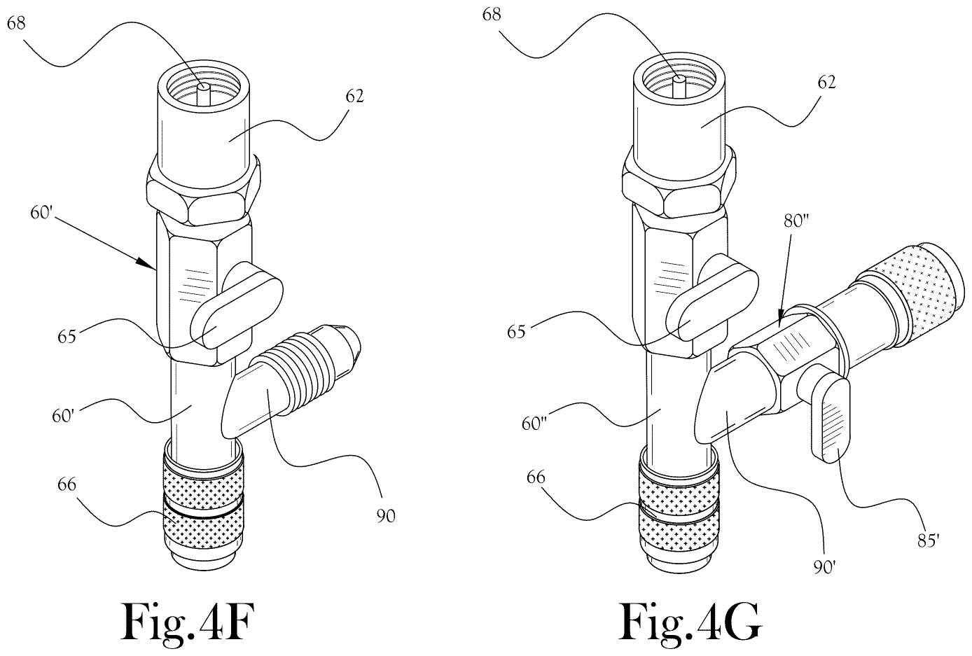

As illustrated in FIGS. 3 and 4A, 4B, 4C, 4D, and 4E kit 10 is provided for filling, or refilling direct inject cartridge 20. It will be appreciated by those skilled in the art that direct inject cartridge 20 has a first end 25 that has a self-sealing valve, which in an exemplary embodiment is an externally threaded Schrader valve and a second end 35 that has a self-sealing valve, which, in an exemplary embodiment, has a Schrader valve with an internally threaded Schrader valve chuck. Direct inject cartridge 20 also includes a cylindrical body 30 which is adapted to contain a selected chemical product, such as a refrigerant gas additive.

As discussed above, such refrigerant additives can include sealants, including conditioners for rubber components such as O-rings, lubricants, dyes, such as UV dyes used for leak detection, system enhancers for reducing energy use or improving heat transfer, drying agents, or a combination of two or more of such additives. Further, in an exemplary embodiment, an improved direct inject cartridge 20 is adapted so as to maintain an internal vacuum of 500 microns or less.

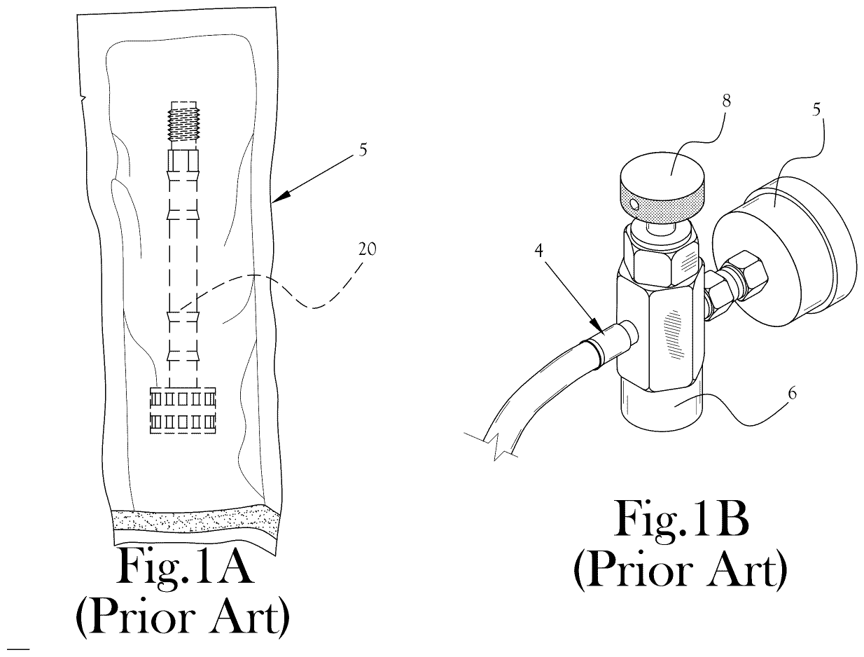

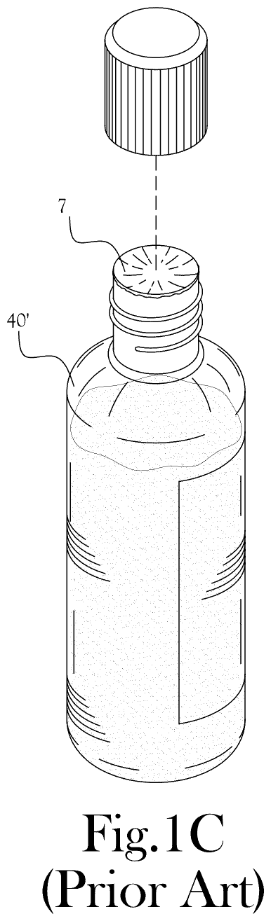

A canister 40 is provided which is filled with the refrigerant additive. In an exemplary embodiment, canister 40 contains only the refrigerant additive under at least a partial vacuum. Canister 40 is under negative pressure, in an exemplary embodiment at least a partial vacuum to ensure that the refrigerant additive within canister 40 is not exposed to atmospheric air which could oxidize or polymerize the refrigerant additive. In a further embodiment, canister 40′ could be utilized. As will be recognized by those skilled in the art, canister 40′, as shown in FIG. 1C, contains a selected chemical product, but the contents are, substantially, under ambient pressure and the lid of canister 40′ is sealed with a foil seal 7 before use.

As will be understood by those skilled in the art, typically, a state-of-the-art aerosol canister in this art contains the refrigerant gas, or refrigerant gas additive, that is intended to be dispensed along with a pressurized gas or liquified gas, typically, a hydrocarbon gas, compressed air, or a fluorocarbon gas, collectively referred to herein as “the propellant”. The pressure of the propellant is what propels the contents of the aerosol canister out of the canister when the self-sealing valve is actuated. And, it will be recognized by those skilled in the art, that a state-of-the-art hose and can tap valve 4, as illustrated in FIG. 1B, includes a fitting 6, a gauge 5, and an actuator knob 8. When the fitting 6 is threadably connected to the self-sealing valve of a conventional aerosol can, actuator knob 8 is used to selectively drive a moveable piercing pin, or valve depressor, into the self-sealing valve.

However, with the refrigerant additives utilized with the present apparatus, use of such a propellant creates an attendant risk of oxidizing or polymerizing the additive and also risks the propellant itself being injected into cartridge 40. This is not desirable because the propellant could contaminate the chilling system being worked on by a technician using direct inject cartridges for introducing a refrigerant additive into the chilling system. Unlike typical aerosol cans which utilize a propellant, canister 40 only contains the refrigerant additive, preferably under negative pressure. Canister 40 includes a self-sealing valve 45 adapted to release the refrigerant additive contained therein only when the valve is actuated. In an exemplary embodiment, self-sealing valve 45 is defined by an externally threaded self-sealing valve.

The kit 10 further includes a first valve member 60, which is disposed between canister 40 and direct inject cartridge 20. First valve member 60 includes a first end 62 defined by an internally threaded collar and adapted to threadably engage and actuate self-sealing valve 45. As illustrated in FIGS. 4C and 4D, first valve member 60 serves as a can tap and includes a first end 62, defined by an internally threaded collar, a pin 68, and a Teflon seal gasket member 64 to ensure a proper seal with canister 40. It will be understood by those skilled in the art that a proper seal between first end 62 and canister 40 could be achieved by other means. Pin 68 engages, and opens, the self-sealing valve 45 of canister 40. As will be understood, pin 68 is hollow and includes an orifice 69 which allows the contents of canister 40 to flow through pin 69, and first valve member 60. Unlike a conventional can tap, pin 68 is fixed relative to the body of first valve member 60. Flow of the contents of canister 40 is selectively actuated by operation of valve actuator 65. When used with a canister such as canister 40′, first end 62 of first valve member 60 is adapted to threadably engage the opening of canister 40′. When first valve member 60 is threadably engaged with canister 40′, pin 68 pierces foil seal 7.

First valve member 60 further includes a second end 66 defined by a Schrader valve chuck and is adapted to engage first end 25 of direct inject cartridge 20 and actuate the Schrader valve of first end 25. First valve member 60 further includes a valve actuator 65 for selectively opening and closing the valve of first valve member 60. While various types of valves could be utilized, in an exemplary embodiment, first valve member 60 is a ball valve. First valve member 60 is adapted to provide selectively actuated fluid communication between either canister 40 or canister 40′ and direct inject cartridge 20.

Kit 10 also includes a second valve member 80 which is disposed between direct inject cartridge 20 and a vacuum pump 15. Second valve member 80 includes a first end 82 adapted to threadably engage the Schrader valve chuck of second end 35 of the direct inject cartridge 20 and thereby actuate the Schrader valve of second end 35. Second valve member 80 further includes a second end 86 adapted to engage a vacuum port provided on vacuum pump 15. Second valve member 80 further includes a valve actuator 85 for selectively opening and closing the valve of second valve member 80. While various types of valves could be utilized, in an exemplary embodiment, second valve member 80 is a ball valve. Second valve member 80 is adapted to provide selectively actuated fluid communication between direct inject cartridge 20 and vacuum pump 15.

As seen in FIG. 3B, kit 10 optionally includes a filter 70 as a safety precaution for protection of pump 15. In this regard, filter 70 is adapted to catch any refrigerant additive that may flow through direct inject cartridge 20 inadvertently due to an accidental opening of valve actuator 65 while valve actuator 85 is either completely or partially opened.

In one aspect of the present disclosure, a system is provided that utilizes kit 10 for filling a new direct inject cartridge 20 or refilling a used direct inject cartridge 20. In accordance with the disclosed system, the components of kit 10 are assembled together as described above, and the second valve member 80 is connected to the vacuum port provided on vacuum pump 15. The components of kit 10 are assembled and, in cooperation with pump 15, operate in functional cooperation to fill direct inject cartridge 20 as will be described hereinbelow.

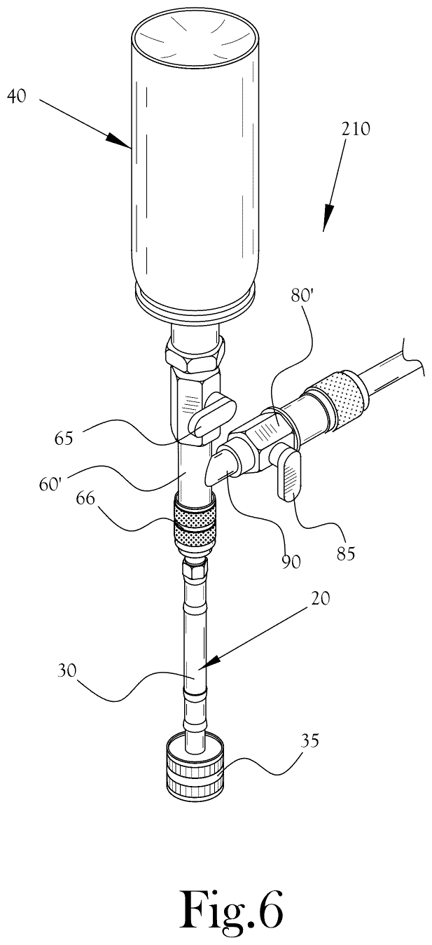

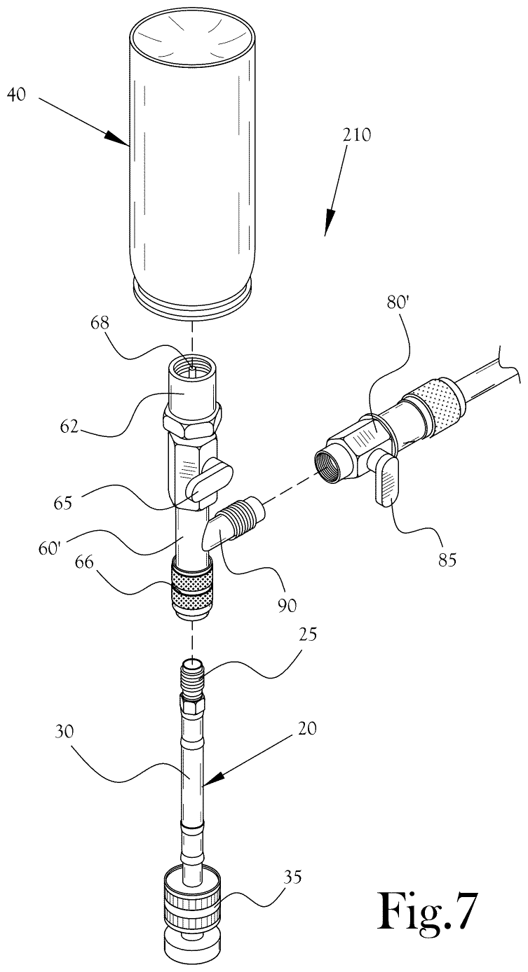

An alternate exemplary embodiment of the kit of the current disclosure is illustrated in FIGS. 4E and 5-10. As illustrated in FIG. 4E, first valve member 60′ serves as a can tap and includes a first end 62, defined by, in an exemplary embodiment, an internally threaded collar, a pin 68, and a seal gasket member 64, which in an exemplary embodiment could be a Teflon gasket, or washer, member to ensure a proper seal with canister 40. Fixed pin 68 engages, and opens, the self-sealing valve 45 of canister 40. As will be understood, fixed pin 68 is hollow and includes an orifice 69 which allows the contents of canister 40 to flow through pin 69, and first valve member 60′. Unlike a conventional can tap, pin 68 is fixed relative to the body of first valve member 60′.

First valve member 60′ further includes a second end 66 defined by, in an exemplary embodiment, a Schrader valve chuck and is adapted to engage first end 25 of direct inject cartridge 20 and actuate the Schrader valve of first end 25. First valve member 60′ further includes a valve actuator 65 for selectively opening and closing the valve of first valve member 60′. While various types of valves could be utilized, in an exemplary embodiment, first valve member 60′is a ball valve. First valve member 60′ is adapted to provide selectively actuated fluid communication between canister 40 and direct inject cartridge 20. Flow of the contents of canister 40 is selectively actuated by operation of valve actuator 65.

A T-fitting 90 is disposed between first valve actuator 65 of first valve member 60′ and second end 66. A second valve member 80′ is adapted to engage T-fitting 90 and is disposed between T-fitting 90 and vacuum pump 15. In an exemplary embodiment, second valve member 80′ is adapted to threadably engage the T-fitting 90 and provide fluid communication between vacuum pump 15 and T-fitting 90 and thereby provide fluid communication between pump 15 and direct inject cartridge 20. A tube 295 is optionally provided between second valve member 80′ and vacuum pump 15. Second valve member 80′ further includes a valve actuator 85 for selectively opening and closing the valve of second valve member 80′. Second valve member 80′ is adapted to provide selectively actuated fluid communication between direct inject cartridge 20 and pump 15. As discussed above, in an exemplary embodiment, an improved direct inject cartridge 20 is adapted with air-tight seals and junctions so as to maintain an internal vacuum of 500 microns or less. Using an improved direct inject cartridge adapted to maintain an internal vacuum of 500 microns or less results in greater pump efficiencies.

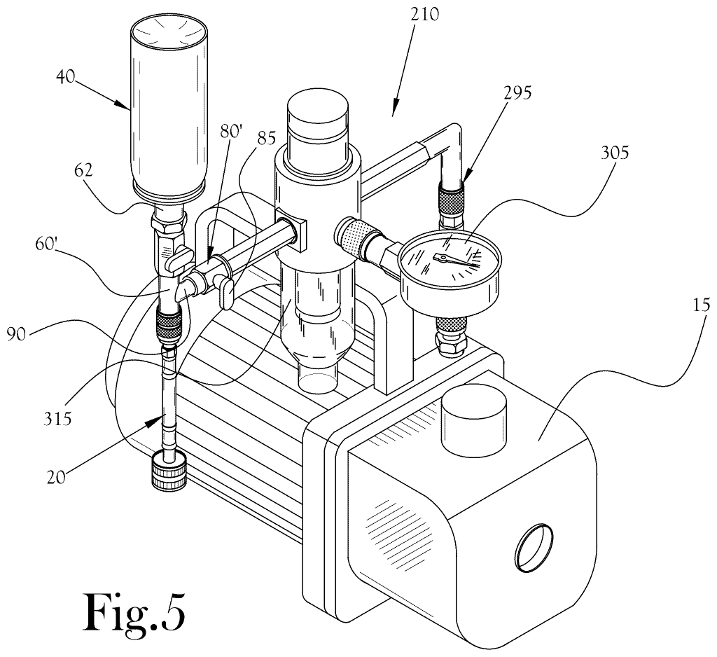

As illustrated in FIGS. 5-10, kit 210 is adapted to provide selective fluid communication between direct inject cartridge 20 and either canister 40 or vacuum pump 15. As described above, direct inject cartridge 20 has a first end 25 that, in an exemplary embodiment is an externally threaded Schrader valve and a second end 35 that, in an exemplary embodiment, has a Schrader valve with an internally threaded Schrader valve chuck. Direct inject cartridge 20 also includes a cylindrical body 30 which is adapted to contain a selected chemical product, i.e., either a refrigerant gas additive or a tire sealant as described above. A canister 40 is provided which is filled with the desired chemical product. In an exemplary embodiment, canister 40 contains the desired chemical product under negative pressure. Canister 40 includes a self-sealing valve 45 adapted to release the desired chemical product contained therein only when the valve is actuated by fixed pin 68.

Kit 210, in an exemplary embodiment, can optionally include a fluid trap 315 disposed between the second valve member 80′ and pump 15. Fluid trap 315 is adapted to prevent the chemical product from being drawn into pump 15 if the second valve actuator 85 is inadvertently left in the open position when the first valve actuator 65 is opened. It should be appreciated by those skilled in the art, that kit 10, described above, could optionally include fluid trap 315 in addition to, or in the place of filter 70. Additionally, a pressure gauge 305 could be placed between the pump 15 and T-fitting 90 and pump 15 in order to determine when the system has been evacuated to a desired negative pressure.

In a further exemplary embodiment, kit 20 or kit 210 further includes an improved direct inject cartridge 20′ as illustrated in FIG. 4C. Direct inject cartridge 20′, as described above, includes a first end 25 that has a self-sealing valve, which in an exemplary embodiment is an externally threaded Schrader valve and a second end 35 that has a self-sealing valve, which, in an exemplary embodiment, has a Schrader valve with an internally threaded Schrader valve chuck. Direct inject cartridge 20 also includes a cylindrical body 30 which is adapted to contain a selected chemical product, such as a refrigerant gas additive.

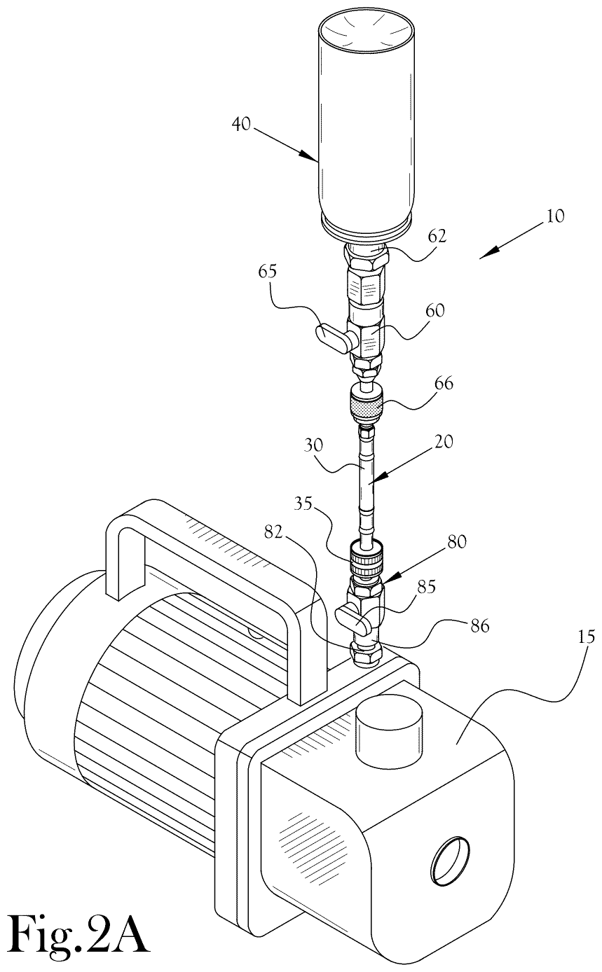

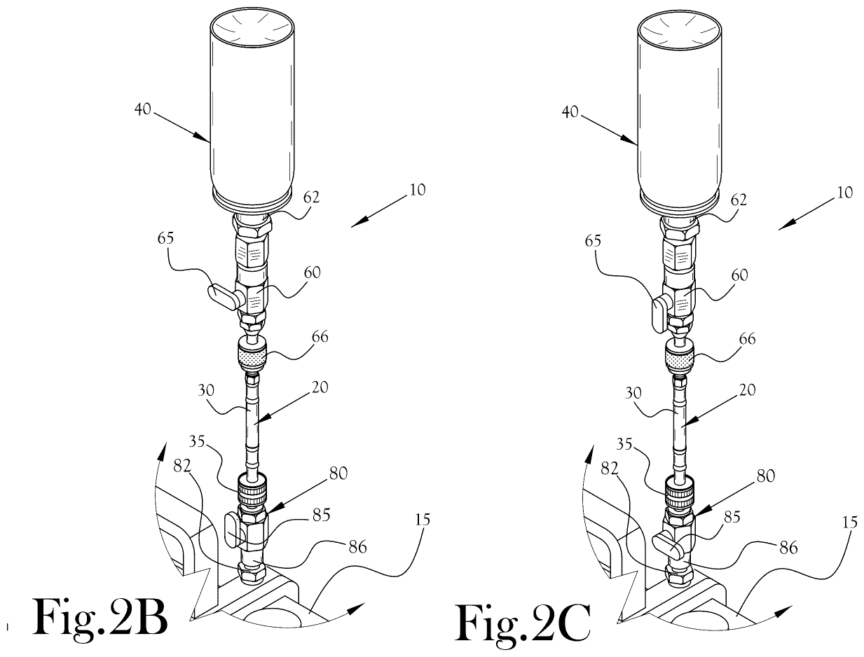

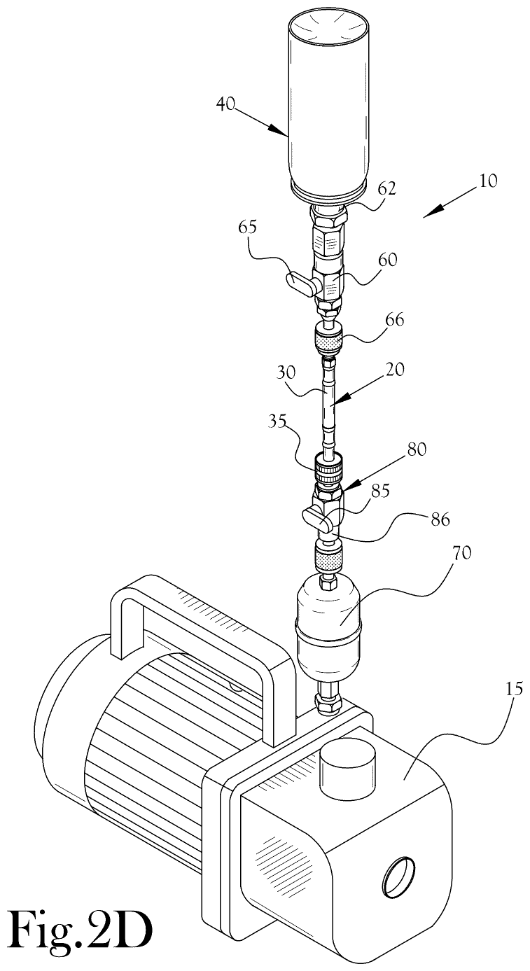

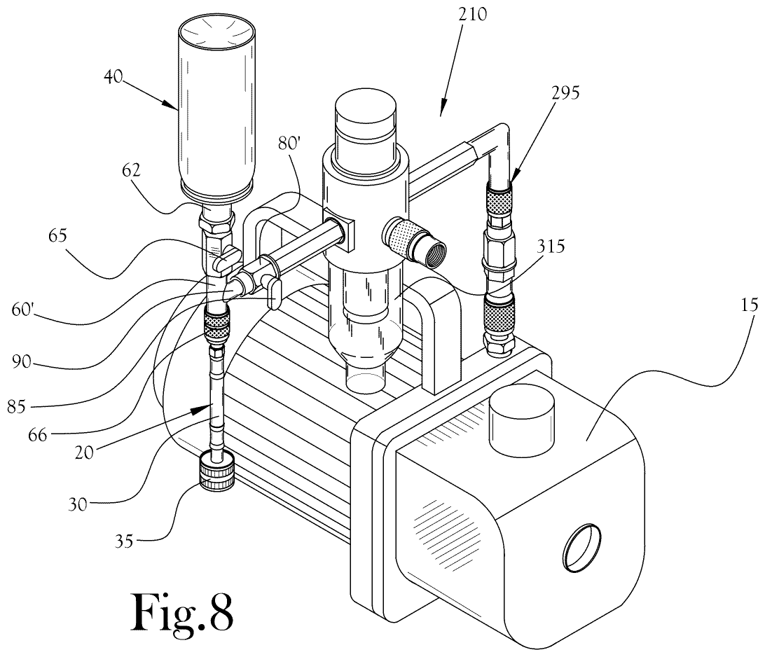

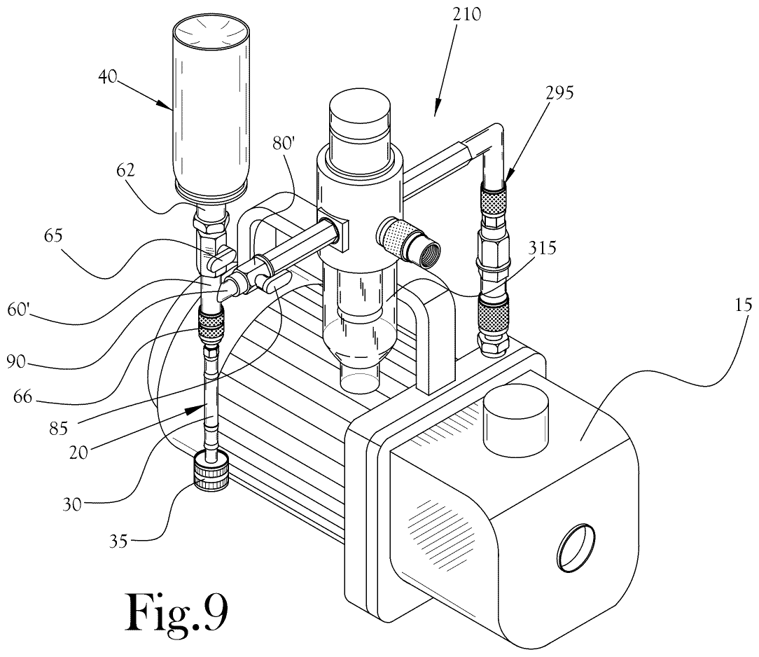

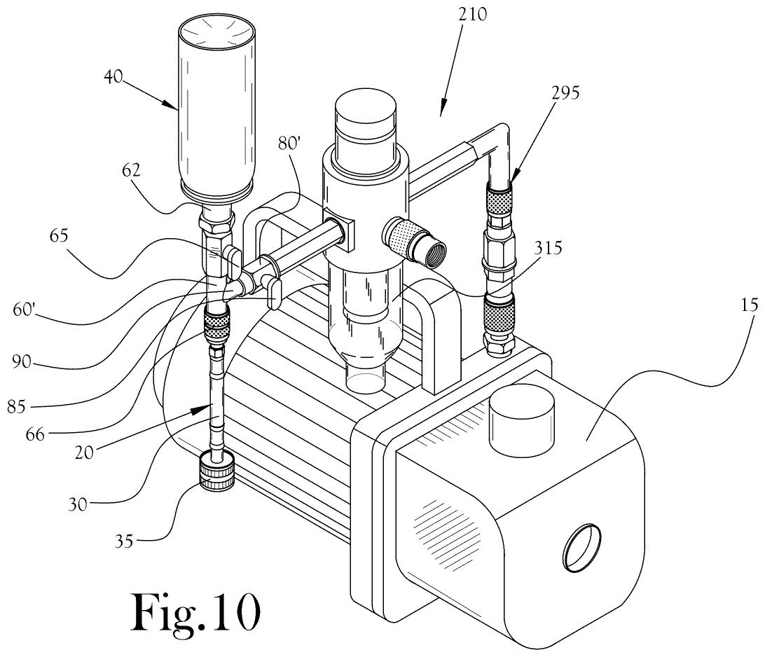

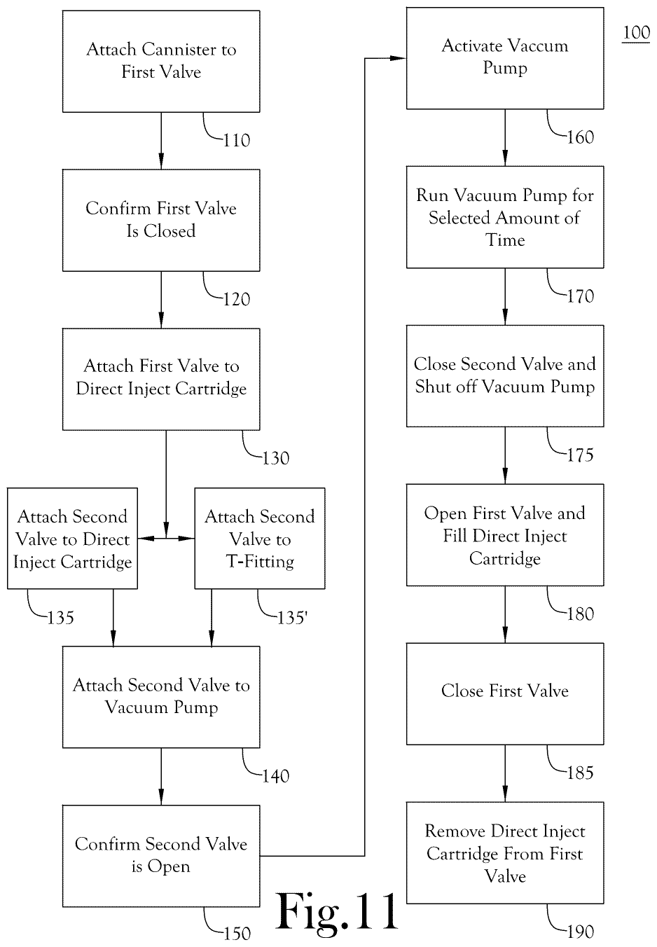

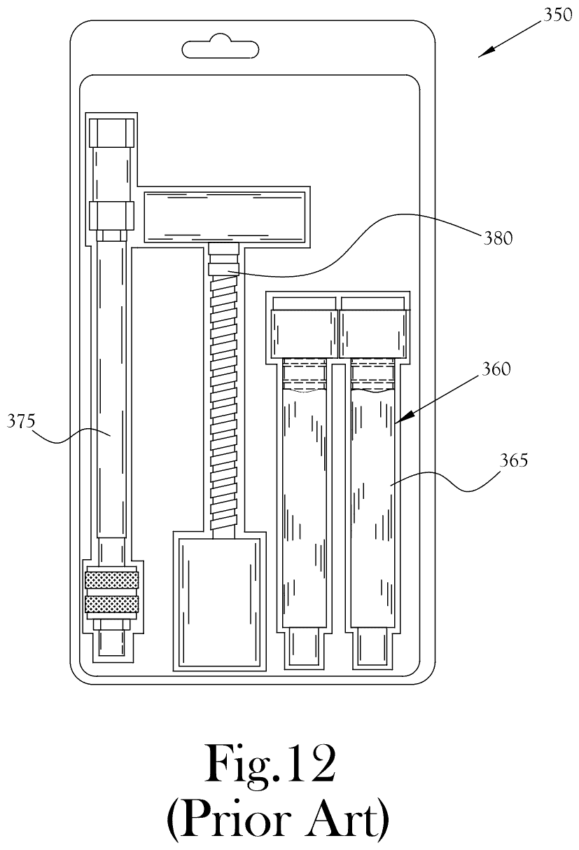

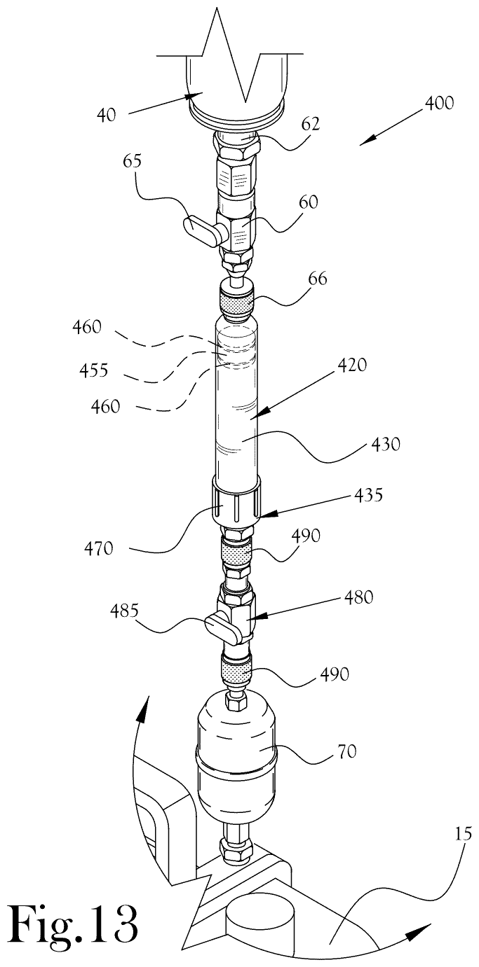

Referring to FIG. 11, the method 100 of using either kit 10 or kit 210 to fill, or to refill, direct inject cartridge 20 will now be described. At step 110, canister 40 is attached to first valve member 60. As described above, canister 40 contains a desired chemical product, preferably under negative pressure. First valve member 60 is confirmed closed, step 120, by ensuring that valve actuator 65 is in the closed position, as illustrated in either FIG. 2B or FIG. 8. First valve member 60 is attached to the direct inject cartridge 20, at step 130. If kit 10 is being used, second valve member 80 is attached to direct inject cartridge 20 at step 135. If kit 210 is being used, second valve member 80′ is attached to T-fitting 90 at step 135′. At step 140, the second valve member 80 or second valve member 80′ is attached to vacuum pump 15. Optionally, fluid trap 315 is positioned between second valve member 80 or second valve member 80′ and vacuum pump 15. Second valve member should be confirmed to be in the open position at step 150 as shown in FIG. 2B and FIG. 9. FIG. 2B and FIG. 9 illustrate the first valve members 60 or 60′ being in the closed position and second valve members 80 or 80′ being in the open position. It should be understood that so long as steps 110, 120, 130, 140 150, and either 135 or 135′ are performed, the sequence or order of performing these steps is not critical.

Once steps 110, 120, 130, 140, 150, and either 135 or 135′ are performed, vacuum pump 15 is activated, step 160, and allowed to run for a selected period of time, step 170. The time for running vacuum pump 15 will depend on the size of the direct inject cartridge, however, allowing vacuum pump to run at least ten seconds, in one exemplary embodiment, and for at least between ten seconds and thirty seconds in a further exemplary embodiment, should be sufficient. Optional pressure gauge 305 can also be used to determine whether the appropriate negative pressure has been reached. After this period of time, and while the vacuum pump is still running, second valve actuator 85 is rotated back to the closed position, step 175, as illustrated in FIG. 2C and FIG. 10, and, vacuum pump 15 is deactivated. The fist valve actuator 65, of either first valve members 60 or 60′ is then rotated to the open position, as illustrated in FIG. 2C and FIG. 10, step 180, and direct inject cartridge 20 is allowed to fill with the desired chemical product. Once direct inject cartridge 20 is filled with the desired chemical product, actuator 65 of first valve actuator 65 is rotated to the closed position, step 185, and the direct inject cartridge 20 is removed from either first valve member 60 or 60′, step 190. If kit 10 is being used, second valve member 85 is also removed from direct inject cartridge 20.

In a further exemplary embodiment, a kit, system, and method are provided for filling, or refilling, a syringe-style direct inject. As illustrated in FIGS. 8-10, kit 400 is provided for filling, or refilling syringe-style direct inject 420. It will be appreciated by those skilled in the art that syringe-style direct inject 420 has a first end 425, which in an exemplary embodiment is an externally threaded nozzle. A second end of syringe-style direct inject 420 includes and cooperates with an adapter cap 435. Adapter cap 435 includes a cap member 470 that is threadably engaged with the second end of syringe-style direct inject 420 and an externally threaded self-sealing valve 465, that, in an exemplary embodiment is defined by a Schrader valve. While an exemplary embodiment utilizes a Schrader valve, those skilled in the art that other types of self-sealing valves could be utilized.

Syringe-style direct inject 420 also includes a cylindrical body 430. Disposed within cylindrical body 430 is a plunger 455 having at least one, and preferably two plunger sealing O-rings 460. Similar to cylindrical body 30 described above, cylindrical body 430 is adapted to contain a selected refrigerant gas additive. As discussed above, such refrigerant additives can include sealants, including conditioners for rubber components such as O-rings, lubricants, dyes, such as UV dyes used for leak detection, system enhancers for reducing energy use or improving heat transfer, drying agents, or a combination of two or more of such additives.

As stated above, in an exemplary embodiment, canister 40 is provided and contains the refrigerant additive. In an exemplary embodiment, canister 40 contains only the refrigerant additive under at least a partial vacuum. Canister 40 is, in an exemplary embodiment, under negative pressure, i.e., at least a partial vacuum, to minimize the risk of exposing the refrigerant additive within canister 40 to atmospheric air which could oxidize or polymerize the refrigerant additive.

The kit 400 further includes first valve member 60, which is disposed between canister 40 and syringe-style direct inject 420. First valve member 60 includes a first end 62 adapted to threadably engage and actuate self-sealing valve 45. As illustrated in FIGS. 4C and 4D, first valve member 60 serves as a can tap and includes a threaded collar 62, a pin 68, and a Teflon seal O-ring 64 to ensure a proper seal with canister 40. Pin 68 engages, and opens, the self-sealing valve 45 of canister 40. As will be understood, pin 68 is hollow and includes an orifice 69 which allows the contents of canister 40 to flow through pin 69, and first valve member 60. Unlike a conventional can tap, pin 68 is fixed relative to the body of first valve member 60. Flow of the contents of canister 40 is selectively actuated by operation of valve actuator 65.

First valve member 60 further includes a second end 66 defined by an internally threaded valve chuck, in an exemplary embodiment, a Schrader valve chuck, and is adapted to threadably engage nozzle 425 of syringe-style direct inject 420. First valve member 60 further includes a valve actuator 65 for selectively opening and closing the valve of first valve member 60. While various types of valves could be utilized for first valve member 60, in an exemplary embodiment, first valve member 60 is a ball valve. First valve member 60 is adapted to provide selectively actuated fluid communication between canister 40 and syringe-style direct inject 420.

Kit 400 also includes a second valve member 480 which is disposed between syringe-style direct inject 420 and a vacuum pump 15. Second valve member 480 includes two, internally threaded valve chucks 490. In an exemplary embodiment, the valve chucks are defined by Schrader valve chucks. One such valve chuck 490 engages threaded fitting 365 of adapter cap 435. Second valve member 480 further includes a second valve chuck 490 adapted to engage a vacuum port provided on vacuum pump 15. Second valve member 480 further includes a valve actuator 485 for selectively opening and closing the valve of second valve member 480. While various types of valves could be utilized, in an exemplary embodiment, second valve member 480 is a ball valve. Second valve member 480 is adapted to provide selectively actuated fluid communication between syringe-style direct inject 420 and vacuum pump 15.

As seen in FIG. 8, kit 400 optionally includes a filter 70 as a safety precaution for protection of pump 15. In this regard, filter 70 is adapted to catch any refrigerant additive that may flow through syringe-style direct inject 420 inadvertently due to an accidental opening of valve actuator 65 while valve actuator 85 is either completely or partially opened.

In one aspect, the disclosure provides a system that utilizes kit 400 for filling a new syringe-style direct inject 420 or refilling a used syringe-style direct inject 420. In accordance with the disclosed system, the components of kit 400 are assembled together as described above, and the second valve member 480 is connected to the vacuum port provided on vacuum pump 15. Alternatively, second valve member 480 is connected to filter 70, which, in turn, is connected to pump 15. The components of kit 400 are assembled and, in cooperation with pump 15, operate in functional cooperation to fill syringe-style direct inject 420 as will be described hereinbelow.

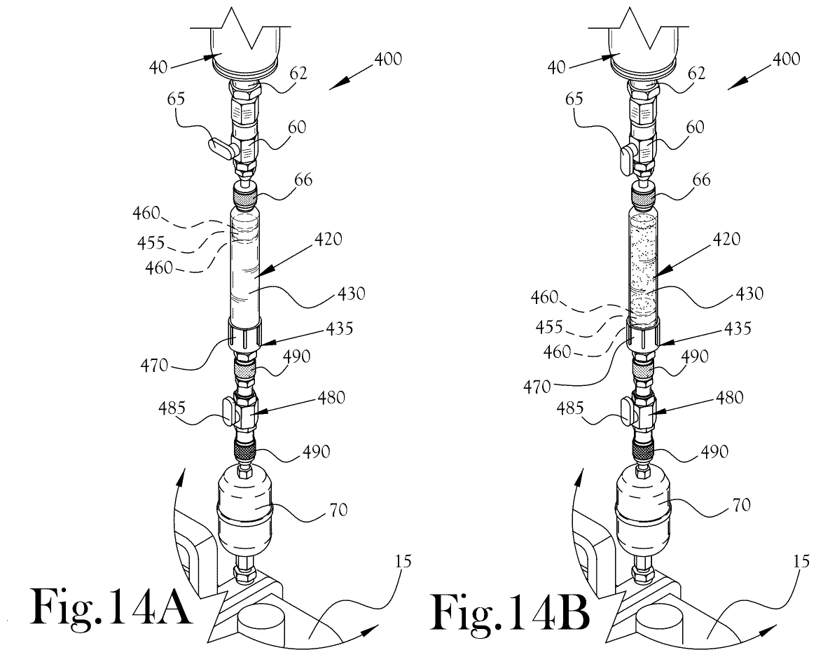

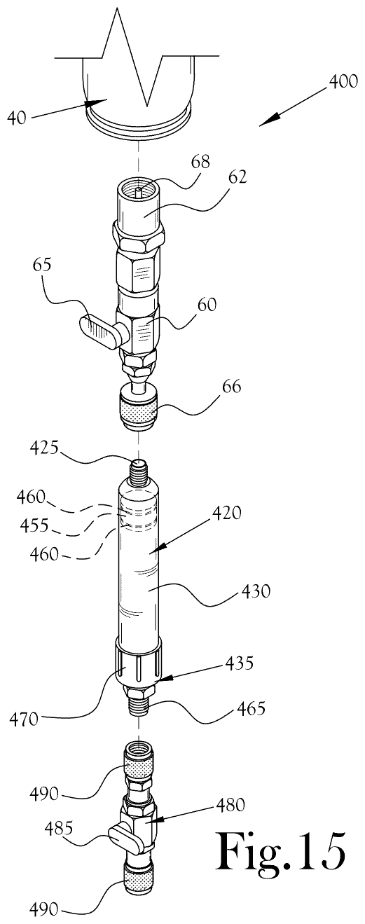

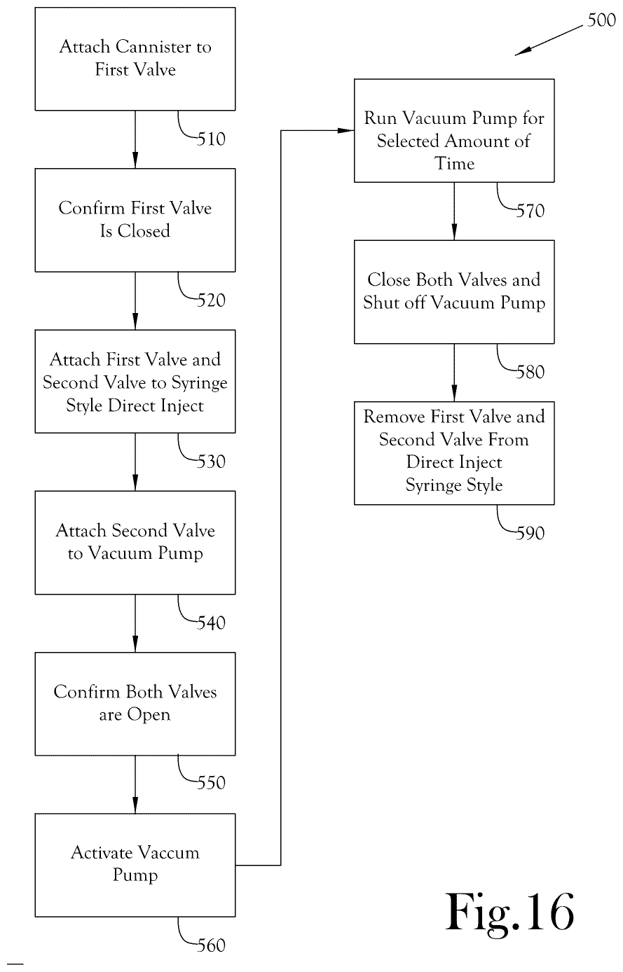

It will be appreciated that syringe-style direct inject 420 could be filled according to the method illustrated in FIG. 11. However, syringe-style direct inject 420 could also be filled according to the steps of the method 500. Referring to FIG. 16, the method 500 of using kit 400 to fill, or to refill, syringe-style direct inject 420 will now be described. At step 510, canister 40 is attached to first valve member 60. As described above, canister 40 contains a selected chemical product, preferably under negative pressure. First valve member 60 is confirmed closed, step 520, by ensuring that valve actuator 65 is in the closed position, as illustrated in FIG. 14A. First valve member 60 is attached to the syringe-style direct inject 420 and, second valve member 480 is also attached to syringe-style direct inject 420 at step at step 530. At step 540, the second valve member 480 is placed in fluid communication with vacuum pump 15. While second valve member 480 could be connected directly to pump 15, optionally, filter 70 could be positioned between second valve member 80 and vacuum pump 15. First valve member 60 and second valve member 480 should be confirmed to be in the open position at step 550. FIG. 14B illustrates both the first valve member 60 and second valve member 480 being in the open position. It should be understood that so long as steps 510, 520, 530, 540 and 550 are performed, the sequence or order of performing these steps is not critical.

Once steps 510, 520, 530, 540 and 550 are performed, vacuum pump 15 is activated, step 560, and allowed to run for a selected period of time, step 570 as necessary to create sufficient negative pressure behind plunger 380 to cause plunger 380 to move within the cylindrical body 430 thereby drawing the selected chemical product from the canister through the open first valve member 60. The time for running vacuum pump 15 will depend on the size of the syringe-style direct inject 420. Once syringe-style direct inject 420 has been allowed to fill with the selected chemical product, actuator 65 of first valve member 60 and actuator 485 of the second valve member 480 are both rotated to the closed position, step 580, and first valve member 60 and second valve member 480 are removed from syringe-style direct inject 420, step 590.

It will be appreciated by those skilled in the art that the various connections described hereinabove as being threaded connections are designed to be substantially air-tight such that the kit or the system can be subjected to negative pressure. It should also be appreciated that other types of connections, such as air-tight quick connect fittings could also be used in place of the threaded connections. These various joints and junctions can utilize gaskets to maintain a vacuum and, as will be understood by those skilled in the art, could be fittings, such as brass compression fittings that also provide liquid and/or air-tight seals.

It will be appreciated that while a technician could use the system of the current disclosure, including either kit 10 or kit 210 and associated method 100 to fill used direct inject cartridges 20 while on a job site, a technician could also refill used and empty direct inject cartridges 20 in a workshop environment prior to going to a jobsite or upon returning from a jobsite. Alternatively, the technician could perform the second part of step 130, i.e., connecting second valve member 80 to direct inject cartridge 20, and perform steps 160, 170, 180, to a plurality of direct inject cartridges in one location. Then the technician could perform steps 110, 120, the first part of 130, and steps 190 and 200, to this plurality of previously evacuated direct inject cartridges 20 in a different location.

Further, the kits 10 and 210 associated method 100 also provide flexibility and allow the technician to be prepared for a variety of scenarios. Rather than carrying a large variety of direct inject cartridges of various capacities and with various refrigerant additives, a technician could carry a plurality of empty direct inject cartridges 20 that have already been evacuated by steps 110 through 180 of method 100. The technician could also carry a plurality of canisters 40 that contain a variety of refrigerant additives. Once the technician has diagnosed the problem at the jobsite and identified the necessary refrigerant additive, the technician could then fill the evacuated direct inject cartridges 20 with the appropriate refrigerant additive by attaching the appropriate canister 40 to the first valve member 60 and attaching the first valve member 60 to the direct inject cartridge 20 and executing steps 190 and 200 of method 100 and removing the first valve member 60 from the direct inject cartridge 20 and the canister 40.

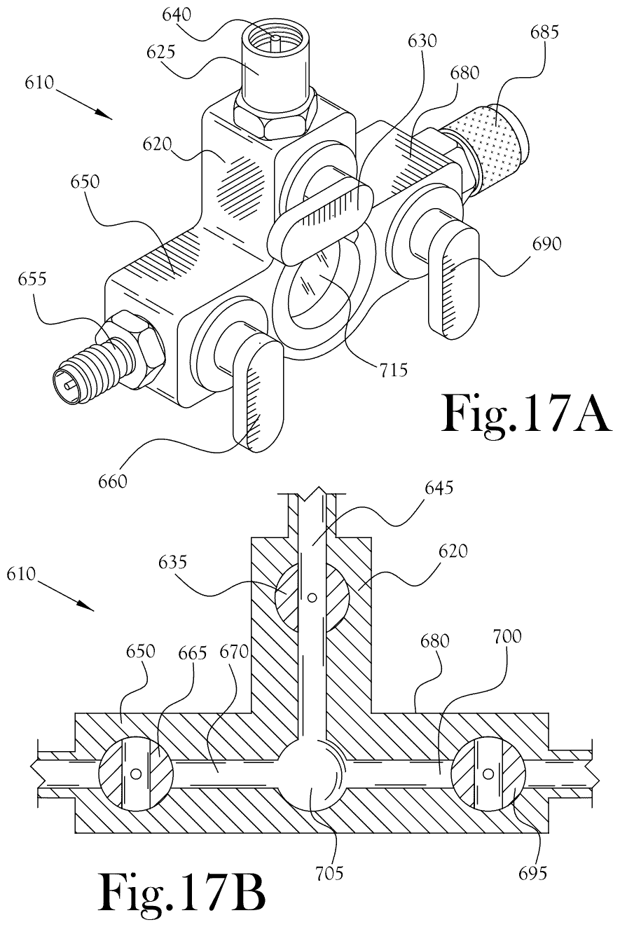

As illustrated in FIGS. 17A through 24, a three-valve manifold 610 for servicing a chilling system, and a method 800, for using three-valve manifold 610 to service a chilling system is provided. In an exemplary embodiment, three-valve manifold 610 includes a first valve body 620, a second valve 650, a third valve body 680 and a central chamber 705. First valve body 620, second valve 650, and third valve body 680, as will be described in greater detail below, are adapted to provide selective fluid communication between a canister of either refrigerant gas additive or refrigerant gas, a vacuum pump, and the low-pressure port 605 of a chilling system.

First valve body 620 includes a can tap 625, having a fixed pin 640, and a first body valve actuator 630. In an exemplary embodiment, the valve in first valve body 620 is a ball valve 635 which is operable between an open and closed position by first body valve actuator 635. Can tap 625, and its fixed pin 640 interact with the Schrader valve on a canister of either refrigerant gas additive or refrigerant gas as described above with regard to as first end 62 of first valve member 60, and like first end 62, is defined by an internally threaded collar, a pin 640, and a Teflon seal gasket member such as Teflon gasket seal 64, to ensure a proper seal with a canister of either refrigerant gas additive or refrigerant gas. Additionally, first valve body 620 includes a longitudinal bore 645 for providing selective fluid communication between a canister of either refrigerant gas additive or refrigerant gas and central chamber 705.

Second valve body 650, similar to second valve member 80 described above, is adapted to provide fluid communication with a vacuum pump. In this regard, second valve body 650 includes a terminal end 655 adapted to engage a vacuum pump via hose 730. Second valve body 650 further includes a second body valve actuator 660. In an exemplary embodiment, the valve in second valve body 650 is a ball valve 665 which is operable between an open and closed position by second body valve actuator 665. Additionally, second valve body 650 includes a longitudinal bore 670 for providing selective fluid communication between the vacuum pump and central chamber 705.

Third valve body 680 includes, in an exemplary embodiment, a Schrader valve chuck 685 adapted to engage the Schrader valve commonly found on a chilling system low-pressure port 605. Further, third valve body 680 includes a valve, which in an exemplary embodiment, is a ball valve 695 which is operable between an open and closed position by third body valve actuator 690. Additionally, third valve body 680 includes a longitudinal bore 700 for providing selective fluid communication between low-pressure port 605 and central chamber 705.

As best illustrated in FIG. 17B, chamber 705 is disposed at the junction of first longitudinal bore 645, second longitudinal bore 670, and third longitudinal bore 700. In this regard, longitudinal bore 645 of first valve body 620, longitudinal bore 670 of second valve body 650, and longitudinal bore 700 of third valve body 680 are arranged in a T-configuration and open into chamber 705 such that each bore is in fluid communication with each of the other bores In an exemplary embodiment, an optional sight glass 715 is provided which provides a view of the contents of the chamber 705. In an exemplary embodiment, chamber 705 is spherical in configuration and is adapted to contain approximately 0.1 to 2 ounces of a chemical product such as refrigerant gas and/or refrigerant gas additive; in a further exemplary embodiment, chamber 705 is adapted to contain approximately 0.5 to 1 ounces of a chemical product such as a refrigerant gas and/or a refrigerant gas additive

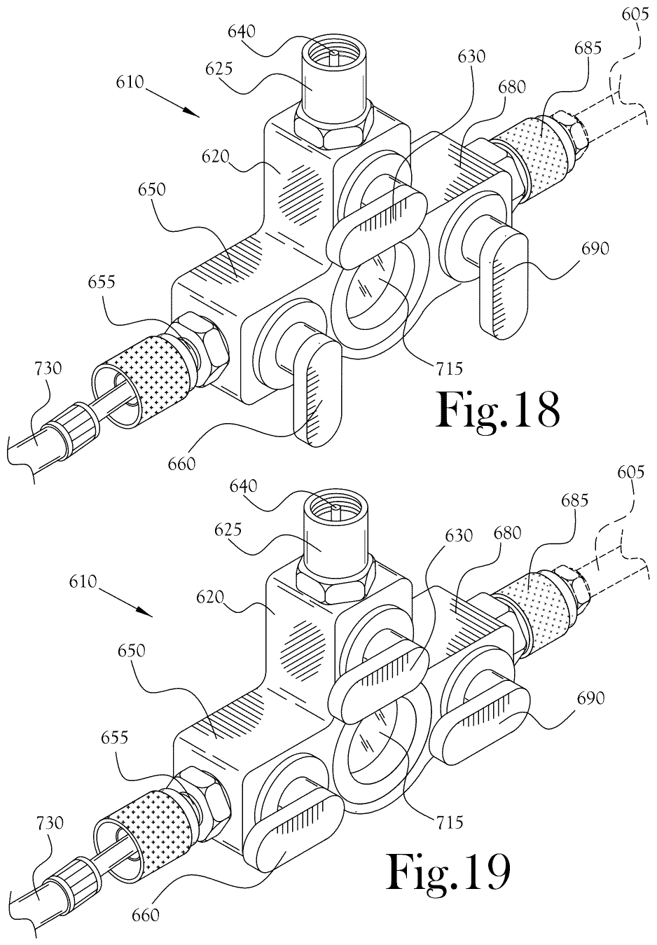

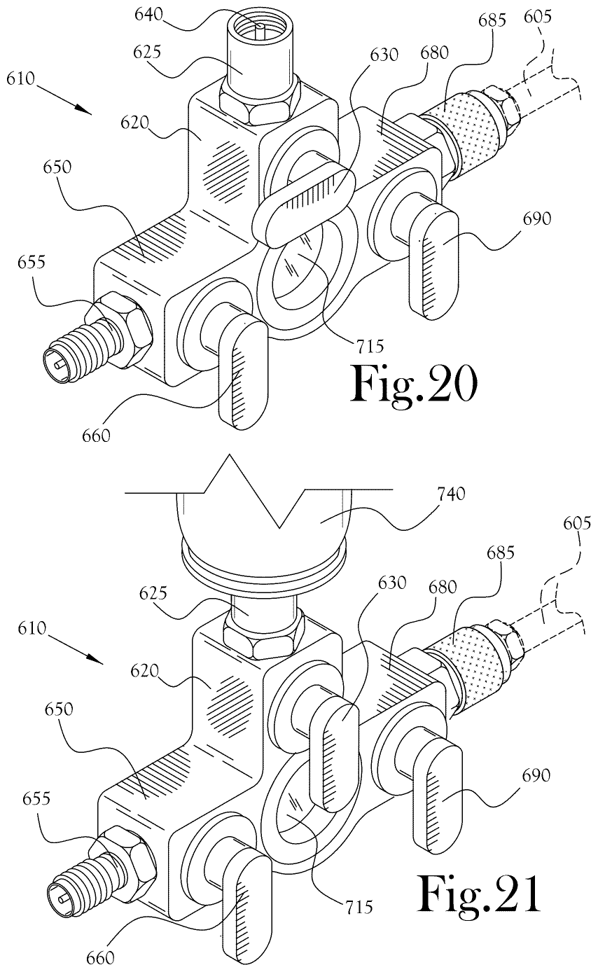

In an exemplary embodiment, method 800 allows the three-valve manifold 610 to be used to service chilling systems via a chilling system's low pressure port 605. Moreover, in an exemplary embodiment, use of three-valve manifold 610 allows a technician to service a chilling system without the cumbersome manifold gauge set. In accordance with method 800, while one of the hoses of a typical manifold gauge set could be used as to connect the second valve body 650 to a vacuum pump such as vacuum pump 15, only a single vacuum hose 730 is required. In accordance with method 800, a user confirms that first valve actuator 630, second valve actuator 660, and third valve actuator 690 are all closed, and vacuum hose 730 is secured to the end 655 of second valve body 650 as illustrated in FIG. 18. As illustrated in FIG. 19, second valve actuator 660 and third valve actuator 690 are placed in the open position, step 810, (first valve member 620 still being closed), and the vacuum pump is actuated to create negative pressure within chamber 705 and the chilling system at step 815. Once chamber 705 and the chilling system are under a vacuum, second valve actuator 660 and third valve actuator 690 are placed in the closed position to isolate chamber 705 and the chilling system so as to maintain chamber 705 and the chilling system under negative pressure at step 820, and as illustrated in FIG. 20. It will be noted that at this point vacuum hose 730 can be removed if desired.

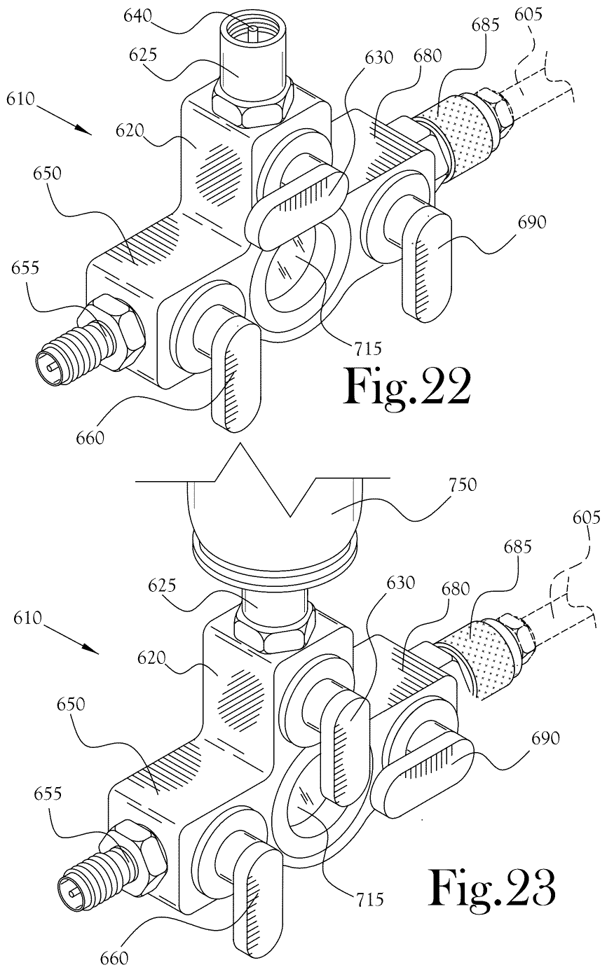

As illustrated in FIG. 21, at step 825, canister 740, containing a selected refrigerant gas additive, is connected to the can-tap end 625 of first valve body 620, and first valve actuator 630 is rotated to the open position allowing a selected quantity of the contents of canister 740 to fill chamber 705. It will be appreciated that canister 740 could be any small container of refrigerant gas additive such as container 40 or canister 40′, described above or could be a direct inject containing a refrigerant gas additive. Thereafter, at step 830, canister 740 is removed from can-tap end 625 of first valve body 620, and first valve actuator 630, second valve actuator 660, and third valve actuator 690 are all closed, isolating the contents of chamber 705 and the chilling system as illustrated in FIG. 22.

Method 800 allows the chilling system to be serviced with either pre-measured small volume canisters of refrigerant gas or with bulk containers of refrigerant gas. Upon completion of steps 810-830, the workflow diverges, at 835, based upon whether or not the technician is using pre-measured, i.e., pre-weighed, small volume, i.e., 100 grams or less, canisters of refrigerant gas. If the technician is using pre-measured, pre-weighed small volume canisters of refrigerant gas, canister 750, in an exemplary embodiment containing 100 grams or less of a selected refrigerant gas, is secured to the can-tap end 625 of first valve body 620 at step 840, and first valve actuator 630 is opened; upon opening of third valve actuator 690, as illustrated in FIG. 23, the volume of refrigerant gas in canister 750 and the refrigerant gas additive in chamber 705 are drawn in to the chilling system at step 845. If an additional canister 750 of refrigerant gas is desired to be injected into the chilling system, first valve actuator 630 and third valve actuator 690 would be closed, an additional refrigerant gas canister 750 would be secured to the can-tap end 625 of first valve body 620; and, first valve actuator 630 and third valve actuator 690 would be opened. Thereafter, third valve actuator 690 would be closed and three-valve manifold 610 would be removed from the low pressure port 605 of the chilling system.

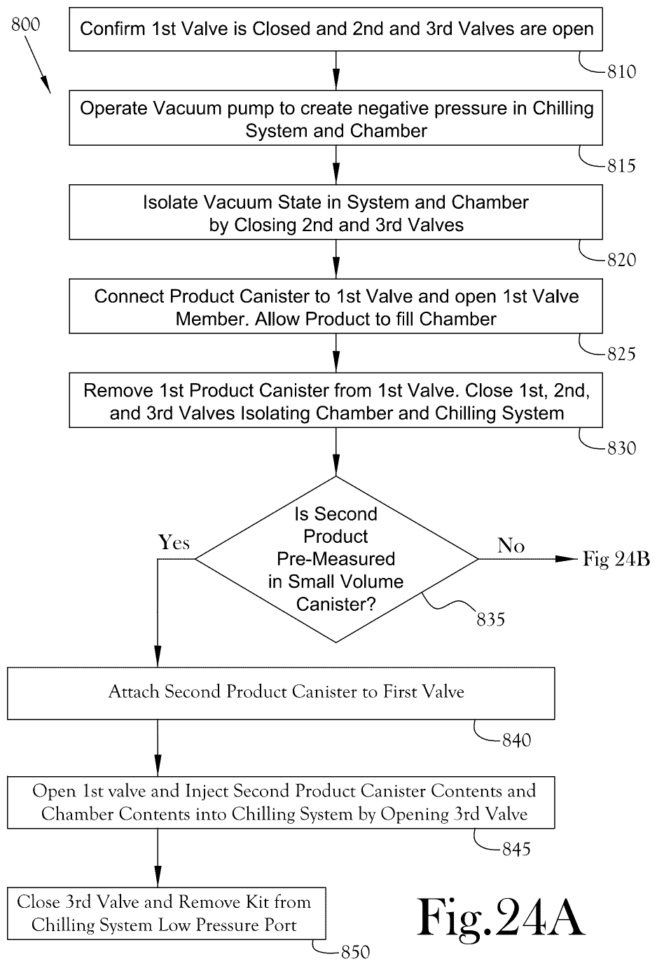

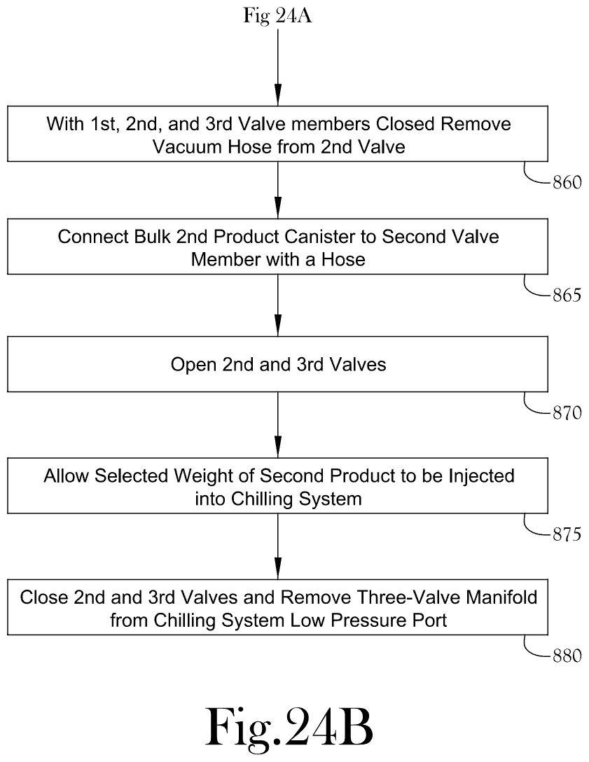

As described above, at 835, the workflow diverges based upon whether or not the technician is using pre-measured, i.e., pre-weighed, small volume, i.e., 100 grams or less, canisters of refrigerant gas. For instance, it is known that typically HVAC technicians carry thirty pound cylinders of refrigerant gas from job site to job site. Regardless of the actual size of the cylinder of refrigerant gas being used, if the container of refrigerant gas contains more than the necessary quantity, or contains an unknown weight of refrigerant gas, such that the container will be weighed during the dispensing process, steps 860-880 will be used. In this regard, and referring to FIG. 24B, after completion of step 830, if the vacuum hose 730 has not already been removed from second valve body 650, vacuum hose 730 is removed at step 860. The bulk canister of refrigerant gas is connected to second valve body 650 with a standard hose. The second valve actuator 660 and third valve actuator 690 are then rotated to the open position.

While the second valve actuator is open, a selected weight of refrigerant gas is allowed to flow into the chilling system. In this regard, in an exemplary embodiment, the bulk canister of refrigerant gas can be weighed during the dispensing process, and the second valve actuator 660 can be selectively operated between a closed position and at least a partially open position in order to dispense the selected quantity of refrigerant gas. Once the selected quantity of refrigerant gas has been dispensed, second valve actuator 660 and third valve actuator 690 are rotated to the closed position and the three-valve manifold 610 is removed from the chilling system low pressure port 605.

While the kit, system, and method of the current disclosure have been illustrated by description of several embodiments and while the illustrative embodiments have been described in detail, it is not the intention of the applicant to restrict or in any way limit the scope of the appended claims to such detail. Additional modifications will readily appear to those skilled in the art. The current disclosure, in its broader aspects, is therefore not limited to the specific details, representative apparatus and methods, and illustrative examples shown and described. Accordingly, departures may be made from such details without departing from the spirit or scope of applicant's general inventive concept.

Having thus described the aforementioned invention, what is claimed is:

1. A kit adapted for filling a direct inject cartridge having a first end, a second end, a self-sealing valve at said first end, and a self-sealing valve at said second end with at least one selected chemical product, the kit comprising:
a first valve member adapted for providing fluid communication between a canister containing said at least one chemical product and the direct inject cartridge, said first valve member having a pin member adapted to provide fluid communication between the canister and the direct inject cartridge, a first end defining a collar adapted to engage said canister, a second end adapted to engage a first end of the direct inject cartridge and a valve actuator for selectively opening and closing a valve of said first valve member, said first valve member further having a T-fitting disposed between said first actuator and said second end; and
a second valve member adapted for engaging said T-fitting and for providing fluid communication between the direct inject cartridge and a vacuum pump, said second valve member having a valve actuator for selectively opening and closing a valve of said second valve member.

2. The kit adapted for filling a direct inject cartridge having a first end, a second end, a self-sealing valve at said first end, and a self-sealing valve at said second end with at least one selected chemical product of claim 1 wherein said pin is adapted to actuate a self-sealing valve of said canister, wherein said first end of said first valve member threadably engages the canister and said wherein said second end of said first valve member threadably engages the direct inject cartridge.

3. The kit adapted for filling a direct inject cartridge having a first end, a second end, a self-sealing valve at said first end, and a self-sealing valve at said second end with at least one selected chemical product of claim 1 wherein said canister is sealed with a foil seal and said pin is adapted to pierce the foil seal of the canister.

4. The kit adapted for filling a direct inject cartridge having a first end, a second end, a self-sealing valve at said first end, and a self-sealing valve at said second end with at least one selected chemical product of claim 1 wherein said first valve member and said second valve member each includes a ball valve.

5. The kit adapted for filling a direct inject cartridge having a first end, a second end, a self-sealing valve at said first end, and a self-sealing valve at said second end with at least one selected chemical product of claim 1, wherein said at least one chemical product is selected from a group consisting of sealants, including conditioners for rubber components and tire sealants, lubricants, dyes, system enhancers adapted for reducing energy use or improving heat transfer, and drying agents.

6. The kit adapted for filling a direct inject cartridge having a first end, a second end, a self-sealing valve at said first end, and a self-sealing valve at said second end with at least one selected chemical product of claim 1, wherein said canister contains said at least one selected chemical product under negative pressure.

7. The kit adapted for filling a direct inject cartridge having a first end, a second end, a self-sealing valve at said first end, and a self-sealing valve at said second end with at least one selected chemical product of claim 1, wherein the self-sealing valves of the direct inject cartridge are Schrader valves, the second end of the direct inject cartridge including a Schrader valve chuck, and further wherein said second end of said first valve member is defined by a Schrader valve chuck and is adapted to engage the first end of the direct inject cartridge and actuate the Schrader valve of the first end of the direct inject cartridge.

8. The kit adapted for filling a direct inject cartridge having a first end, a second end, a self-sealing valve at said first end, and a self-sealing valve at said second end with at least one selected chemical product of claim 6, wherein said first end of said second valve member is adapted to threadably engage said T-fitting of said first valve member.

9. The kit adapted for filling a direct inject cartridge having a first end, a second end, a self-sealing valve at said first end, and a self-sealing valve at said second end with at least one selected chemical product of claim 1, wherein said pin is fixed relative to said first valve member.

10. The kit adapted for filling a direct inject cartridge having a first end, a second end, a self-sealing valve at said first end, and a self-sealing valve at said second end with at least one selected chemical product of claim 1, wherein said kit further comprises a fluid trap disposed between said second valve member and the vacuum pump, wherein said fluid trap is adapted to prevent said chemical product from being drawn into the pump.

11. The kit adapted for filling a direct inject cartridge having a first end, a second end, a self-sealing valve at said first end, and a self-sealing valve at said second end with at least one selected chemical product of claim 1, wherein said kit further comprises a canister having a selectively actuated self-sealing valve, said canister containing said at least one chemical product under negative pressure.

12. The kit adapted for filling a direct inject cartridge having a first end, a second end, a self-sealing valve at said first end, and a self-sealing valve at said second end with at least one selected chemical product of claim 1, wherein said direct inject cartridge is adapted with air-tight seals so as to maintain an internal vacuum of 500 microns or less.

13. The kit adapted for filling a direct inject cartridge having a first end, a second end, a self-sealing valve at said first end, and a self-sealing valve at said second end with at least one selected chemical product of claim 1, wherein said second valve member is integral with said T-fitting of said first valve member.

14. The kit adapted for filling a direct inject cartridge having a first end, a second end, a self-sealing valve at said first end, and a self-sealing valve at said second end with at least one selected chemical product of claim 1, wherein said kit further includes the direct inject cartridge.

15. A method for filling a direct inject cartridge with at least one selected chemical product, said method comprising the steps:
attaching a canister containing at the least one selected chemical product to a first valve member having a valve actuator and a T-fitting, said valve actuator of said first valve member defining a first valve actuator;
confirming said valve actuator of said first valve member is closed;
attaching said first valve member to the direct inject cartridge;
attaching a second valve member having a valve actuator to said T-fitting of said first valve member, said valve actuator of said second valve member defining a second valve actuator;
attaching said second valve member to a vacuum pump;
confirming said second valve actuator is in an open position;
actuating said vacuum pump and running said vacuum pump for a selected period of time thereby evacuating said direct inject cartridge;
closing said second valve actuator;
shutting off said vacuum pump;
opening said first valve actuator whereby said at least one selected chemical product is allowed to flow into said evacuated direct inject cartridge;
closing said first valve actuator; and
removing the direct inject from said first valve member.

16. The method for filling a direct inject cartridge with at least one selected chemical product of claim 15 wherein said steps of attaching a canister containing at the least one selected chemical product to a first valve member; confirming said first valve actuator is closed; attaching said first valve member to the direct inject cartridge; attaching a second valve member to said T-fitting of said first valve member; attaching said second valve member to a vacuum pump; and confirming said second valve actuator is in an open position may be performed in any order relative to each other, provided that all of said steps of attaching a canister containing at the least one selected chemical product to a first valve member; confirming said first valve actuator is closed; attaching said first valve member to the direct inject cartridge; attaching a second valve member to said T-fitting of said first valve member; attaching said second valve member to a vacuum pump; and confirming said second valve actuator is in an open position are completed prior to said step of actuating said vacuum pump.

17. The method for filling a direct inject cartridge with at least one selected chemical product of claim 15 wherein said selected period of time for running said vacuum pump is at least ten seconds.

18. The method for filling a direct inject cartridge with at least one selected chemical product of claim 15 wherein said selected period of time for running said vacuum pump is between ten seconds and thirty seconds.

19. The method for filling a direct inject cartridge with at least one selected chemical product of claim 15 wherein said step of closing said second valve actuator is performed before said step of shutting off said vacuum pump.

20. The method for filling a direct inject cartridge with at least one selected chemical product of claim 15 wherein said canister containing at the least one selected chemical product contains said at least one selected chemical product under negative pressure.

21. A three-valve manifold adapted for servicing a low-pressure port of a chilling system; said three-valve manifold comprising:
a first valve body having a terminal end defining a can tap, said can tap having a fixed pin adapted for engaging a Schrader valve, said first valve body further having a longitudinal bore adapted for providing selective fluid communication between said can tap and the low-pressure port of the chilling system, said first valve body further having a selectively actuated valve mechanism;
a second valve body having a terminal end adapted for engaging a vacuum pump, said second valve body having a longitudinal bore adapted for providing fluid communication between the vacuum pump and the low pressure port of the chilling system, said second valve body further having a selectively actuated valve mechanism; and
a third valve body having a terminal end adapted for engaging the low pressure port of the chilling system, said third valve body having a longitudinal bore adapted for providing fluid communication between the vacuum pump and the low pressure port of the chilling system, said third valve body further having a selectively actuated valve mechanism;
wherein said longitudinal bore of said first valve body, said longitudinal bore of said second valve body, and said longitudinal bore of said third valve body are arranged in a T-configuration, wherein said bores open into a chamber such that each said bore is in fluid communication with each of the other said bores.

22. The three-valve manifold adapted for servicing a low-pressure port of a chilling system of claim 21, said selectively actuated valve mechanism of said first valve body, said selectively actuated valve mechanism of said second valve body, and said selectively actuated valve mechanism of said third valve body each being defined by ball valves.

23. The three-valve manifold adapted for servicing a low-pressure port of a chilling system of claim 21, said chamber is provided with a sight glass to provide a view of contents of said chamber.

24. The three-valve manifold adapted for servicing a low-pressure port of a chilling system of claim 21, wherein said chamber is adapted to contain approximately 0.1 to 2 ounces of a selected chemical product.

25. The three-valve manifold adapted for servicing a low-pressure port of a chilling system of claim 21, wherein said chamber is adapted to contain approximately 0.5 to 1 ounces of a selected chemical product.

26. The three-valve manifold adapted for servicing a low-pressure port of a chilling system of claim 21, wherein said selected chemical product is selected from a group consisting of refrigerant gas, refrigerant gas additive, and a mixture of refrigerant gas and refrigerant.

27. The three-valve manifold adapted for servicing a low-pressure port of a chilling system of claim 21, wherein said terminal end of said third valve body is a Schrader valve chuck adapted for engaging a Schrader valve on the low pressure port of the chilling system.
